(19) United States
(12) Patent Application Publication
(10) Pub. No.: US 2015/0327156 A1
(43) Pub. Date: Nov. 12, 2015

(54) OPTIMIZATION OF MBSFN DECODING ON SCELLS WHEN THE PCELL AND SCELLS BELONG TO SAME MBSFN AREA

(71) Applicant: QUALCOMM Incorporated, San Diego, CA (US)

(72) Inventors: Vasanth Kumar Ramkumar, San Diego, CA (US); Ashish Shankar Iyer, San Diego, CA (US); Kuo-Chun Lee, San Diego, CA (US); Ketan Narenda Patel, Santa Clara, CA (US); Srinivasan Rajagopalan, San Diego, CA (US)

(21) Appl. No.: 14/702,301

(22) Filed: May 1, 2015

Related U.S. Application Data
(60) Provisional application No. 61/989,371, filed on May 6, 2014.

(51) Int. Cl. H04W 48/16; H04W 72/00

(52) U.S. Cl. CPC H04W 48/16; H04W 72/005

(57) ABSTRACT

A mobile device determines that a primary cell (PCell) and a secondary cell (SCell) belong to a same multicast-broadcast single frequency network (MBSFN) area or that the PCell and the SCell can broadcast the same service. The mobile device determines a communication state of the SCell. If the SCell is active, the mobile device compares signal quality on the PCell and the SCell and selects to decode broadcast content on the PCell or the SCell. If the communication state indicating the SCell is deactivated or released, the mobile device switches to decode the broadcast content on the PCell. If the SCell is released and if the mobile device determines that the PCell is also released, then the mobile device switches to decode the broadcast content on the PCell and initiates a neighbor cell search.

### CROSS-REFERENCE TO RELATED APPLICATIONS

This application claims the benefit of priority from U.S. Provisional Patent Application Ser. No. 61/989,371, entitled, “OPTIMIZATION OF MBSFN DECODING ON SCELLS WHEN THE PCELL AND SCELLS BELONG TO SAME MBSFN AREA,” filed on May 6, 2014, the entirety of which application is incorporated herein by reference.

### BACKGROUND

1. Field

Aspects of the present disclosure relate generally to wireless communication systems, and more particularly, to optimization of multicast-broadcast single frequency network (MBSFN) decoding on secondary cells (SCells) when the primary cell (PCell) and SCells belong to the same MBSFN area.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to as mobile entities. A UE may communicate with a base station via a downlink and an uplink. The downlink (or forward link) refers to the communication link from the base station to the UE, and the uplink (or reverse link) refers to the communication link from the UE to the base station. As used herein, a “base station” means an eNode B (eNB), a Node B, a Home Node B, or similar network component of a wireless communications system.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

Recent LTE versions support evolved multimedia broadcast-multicast service (eMBMS) in the LTE air interface to provide the video streaming and file download broadcast delivery. For example, video streaming service is expected to be transported by the DASH (Dynamic Adaptive Streaming using HTTP) protocol over FLUTE (File Delivery over Unidirectional Transport) as defined in IETF RFC 3926 over UDP/IP packets. File download service is transported by FLUTE over UDP/IP protocols. Both high layers over IP are processed by the LTE broadcast channels in PHY and L2 (including MAC and RLC layers). However, such transport includes multiple inefficiencies which are not currently addressed in the communications industry.

### SUMMARY

In an aspect, a method of wireless communication includes determining, by a mobile device, at least one of that a first cell and a second cell belong to a same multicast-broadcast single frequency network (MBSFN) area or that the first cell and the second cell can broadcast the same service. The method additionally includes determining, by the mobile device, a communication state of the second cell. The method also includes selecting, by the mobile device, to decode broadcast content on one of: the first cell, or the second cell, based on a comparison of signal quality on the first cell and the second cell, wherein the selecting is in response to the communication state indicating the second cell is active. The method further includes switching, by the mobile device, to decode the broadcast content on the first cell in response to the communication state indicating the second cell is one of: deactivated or released. The method still further includes, in response to the communication state indicating the second cell is released and a determination that the first cell is released: switching, by the mobile device, to decode the broadcast content on the first cell, and initiating, by the mobile device, a neighbor cell search.

In an aspect, a wireless communications apparatus includes means for determining, by a mobile device, at least one of that a first cell and a second cell belong to a same multicast-broadcast single frequency network (MBSFN) area or that the first cell and the second cell can broadcast the same service. The wireless communications apparatus additionally includes means for determining, by the mobile device, a communication state of the second cell. The wireless communications apparatus also includes means for selecting, by the mobile device, to decode broadcast content on one of: the first cell, or the second cell, based on a comparison of signal quality on the first cell and the second cell, wherein the selecting is in response to the communication state indicating the second cell is active. The wireless communications apparatus further includes means for switching, by the mobile device, to decode the broadcast content on the first cell in response to the communication state indicating the second cell is one of: deactivated or released. The wireless communications apparatus still further includes means for, in response to the communication state indicating the second cell is released and a determination that the first cell is released: switching, by the mobile device, to decode the broadcast content on the first cell, and initiating, by the mobile device, a neighbor cell search.

In an aspect, a non-transitory computer-readable medium having program code recorded thereon. When executed by one or more computer processors, the program code causes the one or more computer processors to determine, by a mobile device, at least one of that a first cell and a second cell belong to a same multicast-broadcast single frequency network (MBSFN) area or that the first cell and the second cell can broadcast the same service. The program code additionally causes the one or more computers to determine, by the mobile device, a communication state of the second cell. The program code also causes the one or more computers to select, by the mobile device, to decode broadcast content on one of: the first cell, or the second cell, based on a comparison of signal quality on the first cell and the second cell, wherein the selecting is in response to the communication state indicating the second cell is active. The program code further causes the one or more computers to switch, by the mobile device, to decode the broadcast content on the first cell in response to the communication state indicating the second cell is one of: deactivated or released. In response to the communication state indicating the second cell is released and a determination that the first cell is released, the program code still further causes the one or more computers to switch, by the mobile device, to decode the broadcast content on the first cell, and initiate, by the mobile device, a neighbor cell search.

In an aspect, an apparatus configured for wireless communication includes at least one processor, and a memory coupled to the at least one processor. The at least one processor is configured to determine, by a mobile device, at least one of that a first cell and a second cell belong to a same multicast-broadcast single frequency network (MBSFN) area or that the first cell and the second cell can broadcast the same service. The at least one processor is additionally configured to determine, by the mobile device, a communication state of the second cell. The at least one processor is also configured to select, by the mobile device, to decode broadcast content on one of: the first cell, or the second cell, based on a comparison of signal quality on the first cell and the second cell, wherein the selecting is in response to the communication state indicating the second cell is active. The at least one processor is further configured to switch, by the mobile device, to decode the broadcast content on the first cell in response to the communication state indicating the second cell is one of: deactivated or released. In response to the communication state indicating the second cell is released and a determination that the first cell is released, the at least one processor is still further configured to switch, by the mobile device, to decode the broadcast content on the first cell, and initiate, by the mobile device, a neighbor cell search.

Aspects of the present disclosure are directed to a method of wireless communication that includes determining, by a mobile device, that a first cell and a second cell belong to a same multicast-broadcast single frequency network (MBSFN) area, determining, by the mobile device, a communication state of the second cell, selecting, by the mobile device, to decode broadcast content on one of: the first cell, or the second cell, based on a comparison of signal quality on the first cell and the second cell, wherein the selecting is in response to the communication state indicating the second cell is active, switching, by the mobile device, to decode the broadcast content on the first cell in response to the communication state indicating the second cell is one of: deactivated or released, and in response to the communication state indicating the second cell is released and a determination that the first cell is released: switching, by the mobile device, to decode the broadcast content on the first cell, and initiating, by the mobile device, a neighbor cell search.

The foregoing has outlined rather broadly the features and technical advantages of the present application in order that the detailed description that follows may be better understood. Additional features and advantages will be described hereinafter which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7 is a functional block diagram illustrating example blocks executed to implement one aspect of the present disclosure.

FIG. 8 is a functional block diagram illustrating example blocks executed to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000. IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE. LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

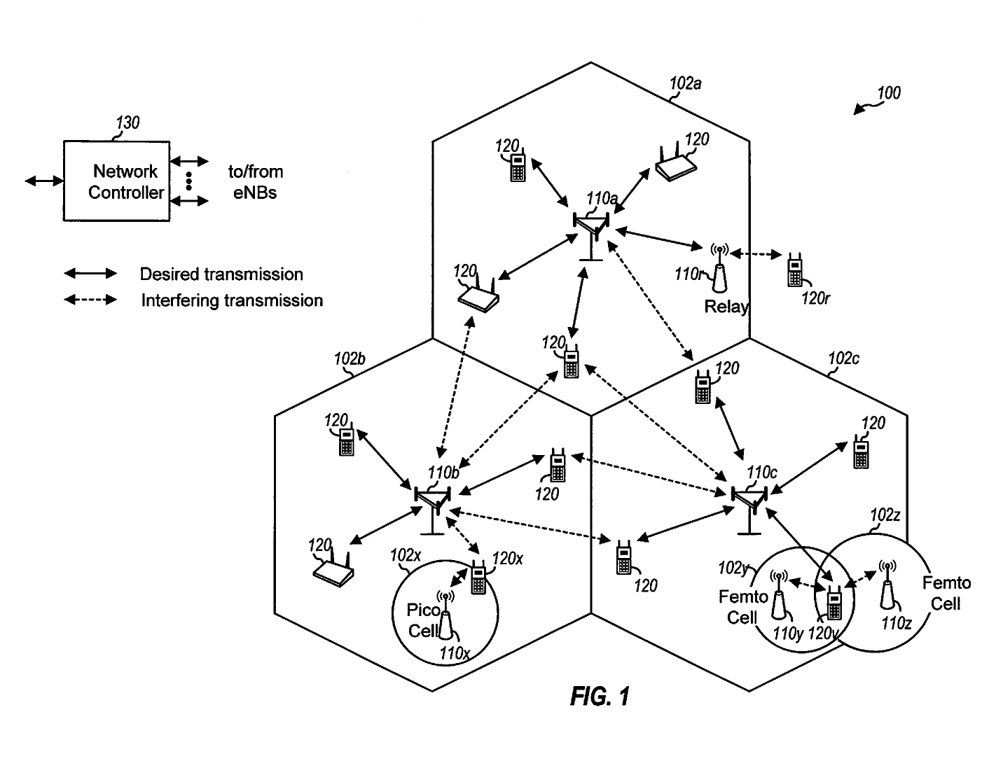

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a tablet, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

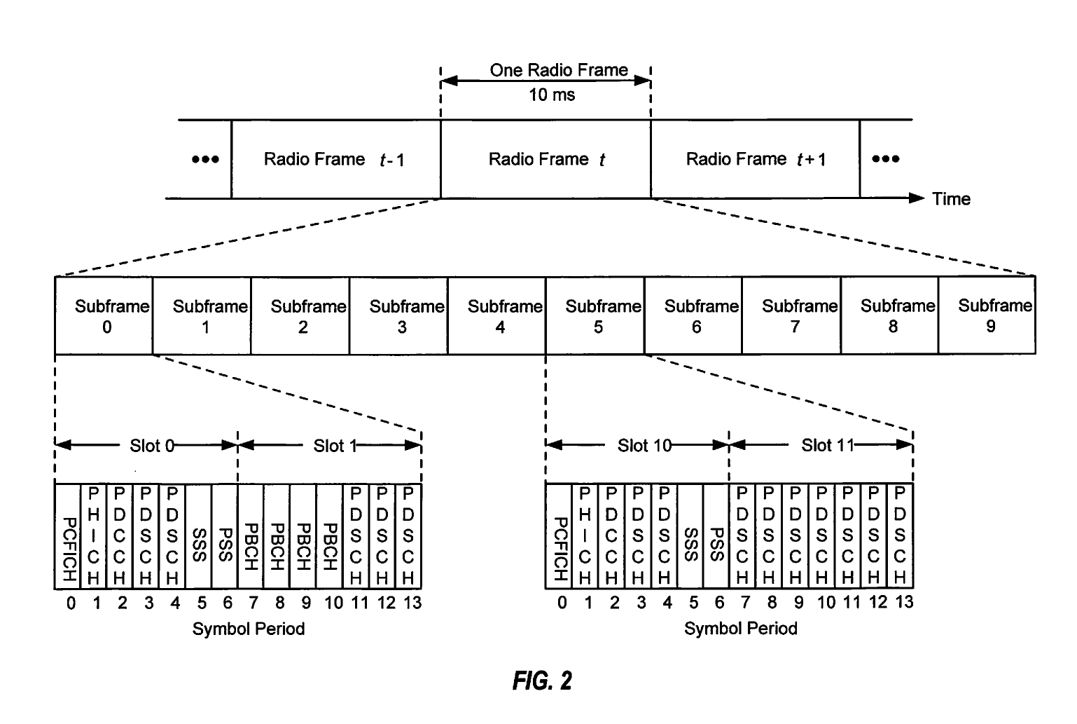

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2. M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control in formation for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

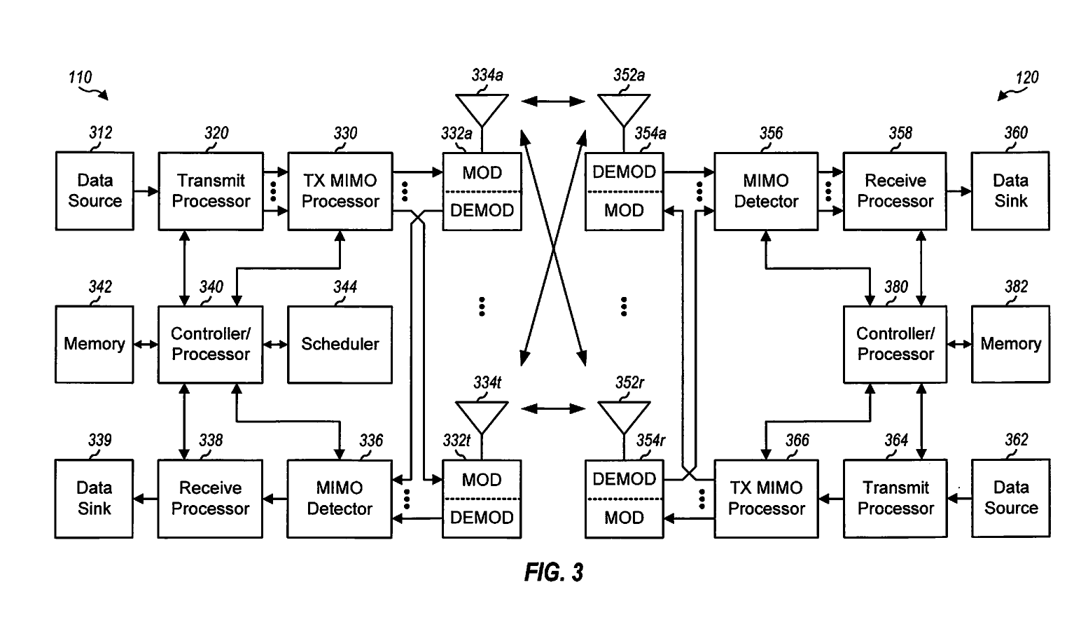

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

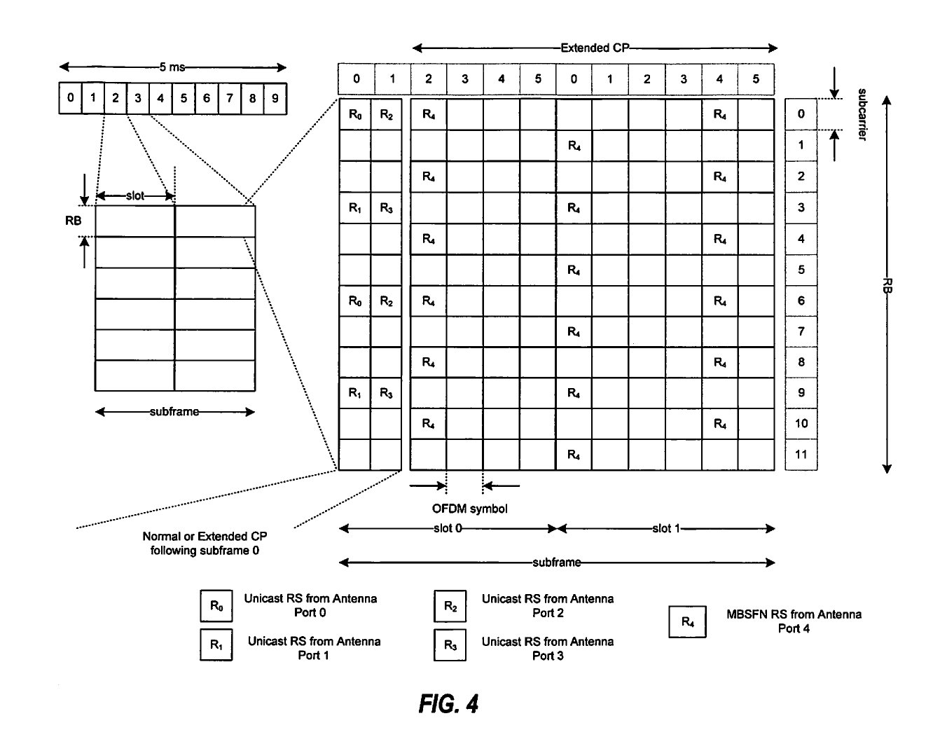

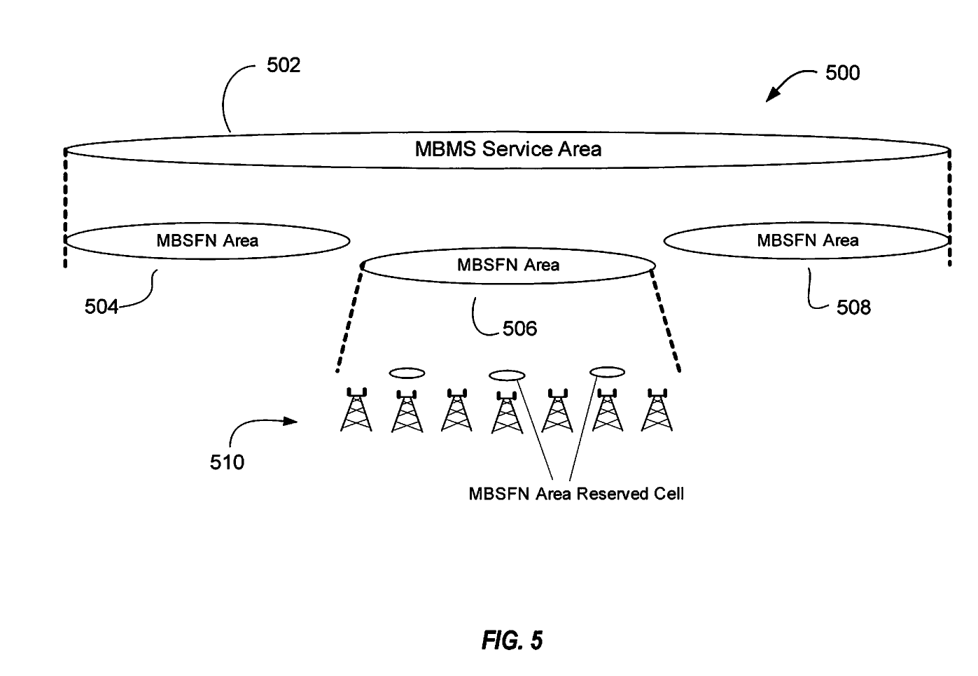

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

eMBMS and Unicast Signaling in Single Frequency Networks:

One technique to facilitate high bandwidth communication for multimedia has been single frequency network (SFN) operation. Particularly. Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB(s) within radio range as part of the eMBMS service area or MBSFN area. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier optimization for eMBMS. eMBMS provides an efficient way to transmit shared content from an LTE network to multiple mobile entities, such as, for example, UEs.

With respect a physical layer (PHY) of eMBMS for LTE Frequency Division Duplex (FDD), the channel structure may comprise time division multiplexing (TDM) resource partitioning between eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBS) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

eMBMS Service Areas:

FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized fashion using an MBSFN protocol. An “MBSFN synchronization area” refers to a group of cells that are interconnected and configured in a way such that they are capable of operating in a synchronized fashion to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support membership in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

eMBMS System Components and Functions:

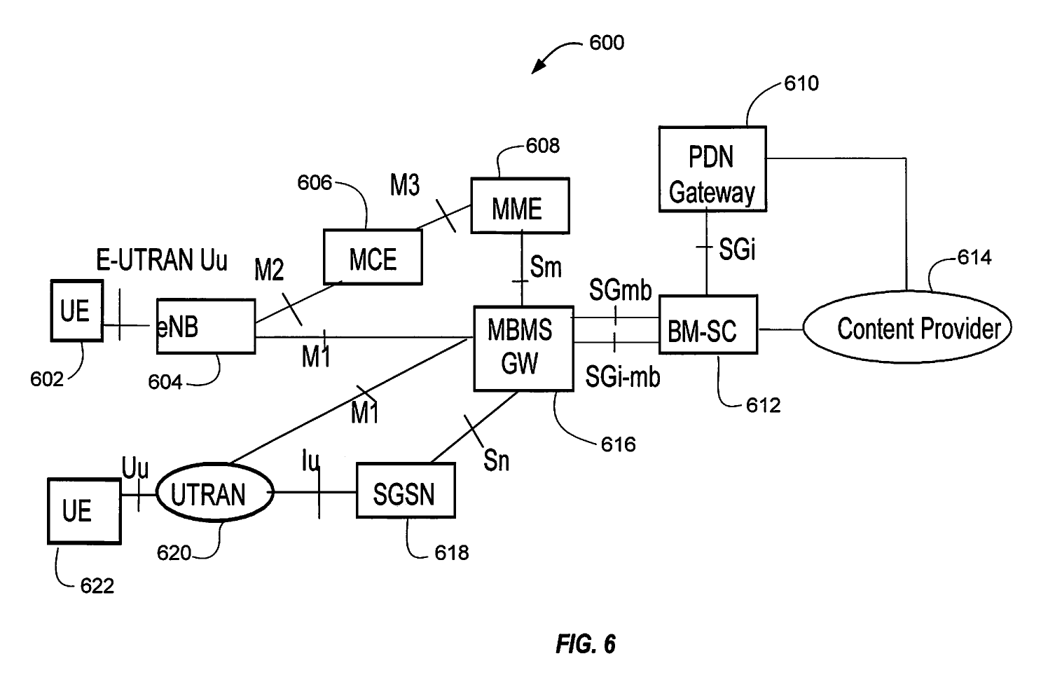

FIG. 6 illustrates functional entities of a wireless communication system 600 for providing or supporting MBSFN service. Regarding Quality of Service (QoS), the system 600 may use a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNodeBs 604 via an M1 interface; one eNB 604 of many possible eNBs is shown. In addition, the MBMS GW controls IP multicast distribution of MBMS user plane data to UTRAN Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a user equipment (UE)/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb Interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedule and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 612 may handle intake of multicast content from one or more sources such as the content provider 614, and provide other higher-level management functions as described below. These functions may include, for example, a membership function, including authorization and initiation of MBMS services for an identified UE. The BM-SC 612 may further perform MBMS session and transmission functions, scheduling of live broadcasts, and delivery, including MBMS and associated delivery functions. The BM-SC 612 may further provide service advertisement and description, such as advertising content available for multicast. A separate Packet Data Protocol (PDP) context may be used to carry control messages between the UE and the BM-SC. The BM-SC may further provide security functions such as key management, manage charging of content providers according to parameters such as data volume and QoS, provide content synchronization for MBMS in UTRAN and in E-UTRAN for broadcast mode, and provide header compression for MBSFN data in UTRAN. The BM-SC 612 may indicate session start, session update and session stop to the MBMS-GW 616 including session attributes such as QoS and MBMS service area.

The system 600 may further include a Multicast Management Entity (MME) 608 in communication with the MCE 606 and MBMS-GW 608. The MME 608 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and session stop signals.

The system 600 may further include a Packet Data Network (PDN) Gate Way (GW) 610, sometimes abbreviated as a P-GW. The P-GW 610 may provide an Evolved Packet System (EPS) bearer between the UE 602 and BM-SC 612 for signaling and/or user data. As such, the P-GW may receive Uniform Resource Locator (URL) based requests originating from UEs in association with IP addresses assigned to the UEs. The BM-SC 612 may also be linked to one or more content providers via the P-GW 610, which may communicate with the BM-SC 612 via an IP interface.

The decision to monitor a multicast-broadcast single frequency network (MBSFN) on a secondary cell (SCell) may be driven by a higher layer configuration, such as a radio resource control (RRC) configuration. An MBSFN configuration for the primary cell (PCell) is generally specified by the network in broadcast messages, such as in system information block (SIB) message 13 (SIB13) or MCCH. SIB 13 can indicate available MBSFN areas and MCCH can indicate the available eMBMS services, identified by Temporary Mobile Group Identity (TMGI). An MBSFN configuration for SCells is generally part of the radio resource configuration received for SCells. In actual deployment, the MBSFN area for the PCell and an SCell could overlap and the same MBSFN area is deployed in both the PCell and an SCell. Hence, a UE may encounter situations in which the UE has to monitor the MBSFN transmission on both the PCell and SCell. If the PCell and SCell belong to the same MBSFN synchronization area, it is likely that the PCell and SCell have the same MBSFN content/information. Otherwise, if the PCell and SCell belong to different MBSFN areas, the same content may also be duplicated in different MBSFN areas. Therefore, the UE can determine that the same content is duplicated when the TMGI of interest is in the MCCH of the PCell as well as in the MCCH of the SCell.

MBMS and eMBMS control information is generally broadcast by the network through SIB messages, such as SIB 13. The UE may decode such SIB messages from both the PCell and SCell to determine the MBSFN area to which each cell belongs. Collecting SIB 13 from the PCell and sequentially collecting SIB 13 from the SCell may be accomplished using multiple radios. By comparing the MBSFN area for the PCell and SCell, if they belong to same MBSFN area, then the same content is expected to be broadcasted. Similarly, the UE may decode MCCHs from the PCell and an SCell to determine the list of available TMGIs. By acquiring the MCCHs for the PCell and SCell, if the interested TMGI is in MCCHs of both the PCell and an SCell, then the same content is expected to be broadcasted.

The UE may act as a diversity receiver by concurrently attempting to decode the physical multicast channel (PMCH) on both the PCell and an SCell for better PMCH decode performance. If the UE is aware that both the PCell and SCell belong to same MBSFN area or if MCCHs of both the PCell and SCell include the same TMGI, various aspects of the present disclosure provide for optimizations that may assist in prioritizing MBSFN reception from the two cell types.

The various aspects of the present disclosure provide for optimizations of PMCH decoding for different conditions regarding the activation and connection states of an SCell. In a first condition, an SCell associated with the UE is in an active state. In a second condition, an active SCell is deactivated. In a third condition, all SCells are released from association or communication connection with the UE, and the UE falls back to single carrier mode in an RRC connected state. In a fourth condition, all SCells are released and the RRC connection of the PCell is also released. The optimizations that may be applied by the UE depend on the particular condition. The eNB can send MAC control elements to activate or deactivate a SCell.

In the first condition, in which an SCell associated with a UE is in an active state, the reference signal receive power (RSRP) of the neighbor cells, including SCells, may be known by the UE due to the neighbor search and measurement process. When the MBSFN signal transmission for the SCell and PCell are the same, the UE could use the reference signal receive quality (RSRQ) metric for the SCell to make dynamic decisions on which cell to monitor for MBSFN reception (e.g., PCell or SCell). An RSRQ on the SCell that is worse than the RSRQ of the PCell may indicate more loading on the SCell than on the PCell. Therefore, the UE may dynamically determine to switch to the PCell for better MBSFN decode performance. The RSRP/RSRQ may be measured on either a unicast reference signal or an eMBMS reference signal.

If the UE continues to monitor the conditions and/or quality of the MBSFN transmissions on the SCell, based on the RSRQ, the UE may also monitor the MBSFN signal-to-noise ratio (SNR) metric, derived from MBSFN RS symbols, to further determine whether the UE should continue monitoring MBSFN on SCell or switch to monitoring MBSFN on the PCell. A degrading MBSFN SNR metric could prompt the UE to switch MBSFN decoding from the SCell to the PCell in order to allow better eMBMS content reception.

In the second condition, in which the SCell is deactivated, if the UE were already monitoring MBSFN on the SCell before deactivation, the UE may consider switching back to monitoring on the PCell, if PCell's channel conditions (e.g., RSRP and/or RSRQ) are good. This would reduce the processing overload associated with PMCH decodes from both the cells and may reduce UE power consumption by turning off the receive chain circuitry associated with the SCell. Once the UE switches to monitoring MBSFN on the PCell, if the success rate of PMCH decodes in a last predetermined number of subframes falls below a preconfigured threshold, the UE may re-start PMCH decodes on the deactivated SCell. It should be understood that the SCell will still be broadcasting eMBMS even though the SCell is deactivated from a unicast perspective. Therefore, once the session starts, it will continue to broadcast without being affected by SCell deactivation.

For the third condition, in which all SCells are released and the UE falls back to single carrier mode in an RRC connected state with the PCell, the UE may fall back to decoding PMCH on the PCell as soon as the SCells are released. As with the second condition, after this fall back, if the success rate of PMCH decodes in a last predetermined number of subframes falls below a preconfigured threshold, the UE may initiate a neighbor search request for available neighbors. If the RSRP and/or RSRQ of one of the neighbors is better than that of the other neighbor cells, the UE may attempt to decode SIB 13 of the higher-quality neighbor using a second radio and opt to attempt PMCH decodes if this new neighbor belongs to the same MBSFN area.

In the fourth condition, where all SCells are released and the RRC connection for the PCell is also released, the UE, now in an idle mode with the PCell, would continue monitoring PMCH decodes on the PCell. If the success rate of PMCH decodes in a last predetermined number of subframes falls below a preconfigured threshold on the PCell, the UE would attempt reselection immediately to a better neighbor, where “better” here refers to better in terms of RSRP and/or RSRQ measurement in relation to a pre-configured threshold. When such better neighbor is identified, the UE would perform reselection even if other reselection criteria may not be met in order to allow un-interrupted viewing. For example, typical reselection criteria may first require the signal quality of the currently serving cell to fall below a specific threshold before considering reselection. Instead, if the PMCH decode success rate falls below the preconfigured threshold, the UE would trigger the reselection process to the better neighbor cell regardless of whether the quality of the currently serving cell falls below the specific threshold quality.

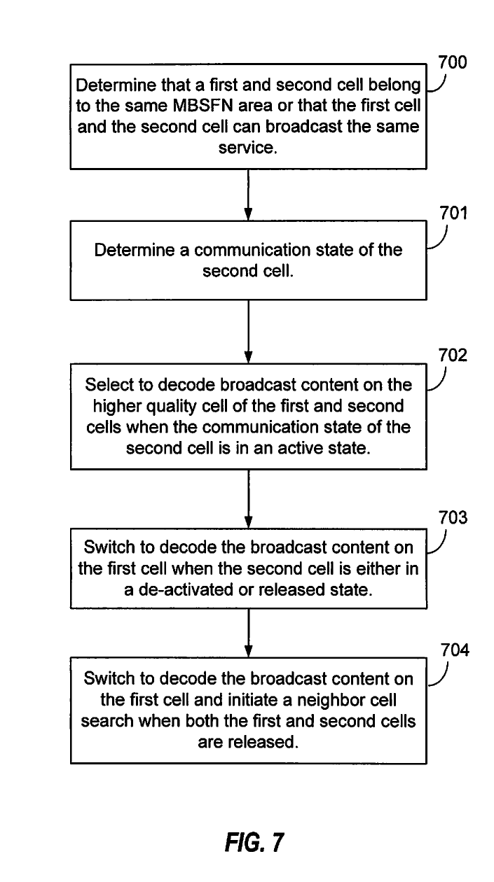

FIG. 7 is a functional block diagram illustrating example blocks executed to implement one aspect of the present disclosure. At block 700, a UE determines that a first and second cell belong to the same MBSFN area or a first cell and second cell can broadcast the same service. The first and second cell may be a PCell and at least one SCell. As the UE begins execution of the various blocks, the UE is decoding broadcast content transmitted over the PMCH on the second cell.

At block 701, the UE determines a communication state of the second cell. The communication state identifies whether the second cell is in an active state, a de-activated state, a fully released state, and the like. The UE may determine the active/deactivated/released state of the SCell via the eNB's signaling in RRC messages and/or a MAC control element to release/activate/deactivate the SCell. At block 702, the UE selects to decode the broadcast content transmitted on the higher quality cell of the first and second cells when the communication state of the second cell is in an active state. For example, when the UE detects the second cell is in an active state, the UE may evaluate or determine the quality of the first and second cells and then compare the quality of the two cells. The cell having the higher quality will be selected by the UE for decoding of the PMCH on that cell to obtain the broadcast content.

At block 703, the UE determines to switch the decoding of the broadcast content to the first cell when the communication state of the second cell is either in a deactivated state or a released state. The UE may then monitor the decoding success and/or the quality of the cell on which the decoding has been switched to in order to determine whether to maintain decoding on the switched-to cell.

At block 704, the UE determines to switch the decoding of the broadcast content to the PMCH on the first cell and initiate a neighbor cell search when both the first and second cells have been released. In such a circumstance, with both cells released and not connected, there may be additional neighbor cells within the same MBSFN area that would provide better decoding success on the PMCH of that cell.

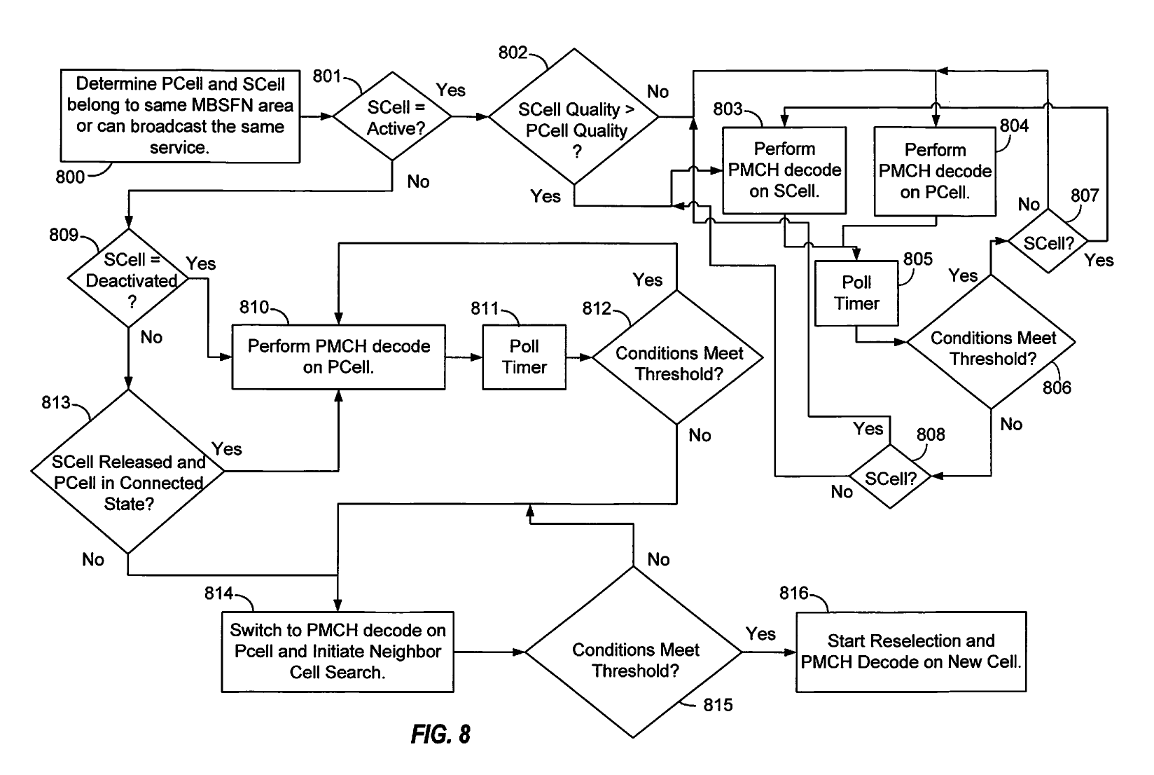

In a more detailed example of one aspect of the present disclosure, the UE operates and communicates with a PCell and at least one SCell for eMBMS data services. FIG. 8 is a functional block diagram illustrating example blocks executed to implement one aspect of the present disclosure. At block 800, a UE determines whether a PCell and SCell belong to the same MBSFN area or whether both the PCell and SCell can broadcast the same service. With the PCell and SCell in the same MBSFN area, it is likely that both cells will have the same eMBMS content or information. Otherwise, if a PCell and SCell do not belong to the same MBSFN area, the same eMBMS service can be duplicated in both the PCell and the SCell as indicated by TMGIs in the MCCHs.

At block 801, a determination is made by the UE on whether the SCell is in an activated state. If so, then, at block 802, the signal quality on the SCell is compared with the signal quality of the PCell. The UE may compare the signal quality for the PCell and SCells using various signal metrics, including RSRQ, RSRP, and the like. As illustrated, the UE compares the RSRQ of the SCell with the RSRQ of the PCell. If the signal quality of the SCell is greater than the signal quality of the PCell, then, at block 803, the UE selects to perform decoding of the data broadcast on the PMCH on the SCell. Otherwise, if the signal quality of the PCell is greater than the signal quality of the SCell, then, at block 804, the UE selects to perform decoding of the PMCH on the PCell for the broadcast data.

After the UE has selected either the PCell or SCell for PMCH decoding in response to the determination at block 802, the continued success of PMCH decoding is analyzed by comparing, at block 806, the decode success rate and/or monitoring the MBSFN signal-to-noise ratio (SNR) of the SCell against the appropriate predetermined threshold(s). It should be noted, however, that the UE may monitor this continued decoding success over a certain monitoring window. Thus, prior to the determination made at the comparison of block 806, a poll timer may be run, at block 805, which allows for a sufficient amount of time to monitor the continued communication conditions.

If the continued communication conditions meet their respective predetermined thresholds, then, if the current cell on which PMCH is being decoded is an SCell, as determined at block 807, the UE continues, at block 803, to decode the PMCH of the SCell for the data. If the current cell is a PCell, then, decoding continues on the PCell at block 804. Otherwise, if the continued communication conditions fail to meet their respective predetermined threshold values, then, if the current cell on which PMCH is being decoded is an SCell, as determined at block 808, the UE will switch, at block 804, to decoding the PMCH of the PCell for the data content. If the current cell is a PCell, then, the UE will switch, at block 803, to decoding the PMCH of the SCell for the data content.

At the determination of block 801, if the UE determines that the SCell is not active, then, at block 809, another determination is made whether the SCell is in a de-activated state. An SCell may be configured for a particular UE, but may not always be active. Thus, when the SCell is determined to be in a de-activated state, then, at block 810, the UE would switch to decoding the PMCH on the PCell to obtain the data content. As noted above, the UE would then monitor the continued success of the switched PCell PMCH decoding over a certain monitoring window defined by the poll timer at block 811, and analyze the continued communication conditions at block 812. As described above, dependent on the continued communication condition relation to the predetermined threshold, the UE may continue decoding PMCH on PCell or switch again to decoding PMCH on the SCell. Thus, if the continued communication condition meets the threshold, then, the UE continues to decode the PMCH on the PCell at block 810. Otherwise, if the continued communication condition fails to meet the threshold, then the UE will decode the PMCH on the PCell and initiate a neighbor cell search, at block 814.

If the SCell is both not active, determined in response to block 801, and not de-activated, determined in response to block 809, then, at block 813, a determination is made whether the SCell has been released and whether the PCell is in a connected state. If the SCell is released and the PCell is in a connected state, then, the UE continues decoding the PMCH on the PCell, at block 810. The UE, again, follows the processing of blocks 811 and 812. If, however, the SCell is released and the PCell is not in a connected state, then, at block 814, the UE decodes the PMCH on the PCell and initiates a neighbor cell search. With the SCell released and the PCell not in a connected state, then the likelihood is that the UE may not have adequate service from these cells and would want to find new cells through a neighbor search.

At block 815, another determination is made that monitors and compares the continued communication conditions (e.g., the decode success rate, MBSFN SNR, and the like) against corresponding predetermined thresholds. If the continued communication condition meets the predetermined threshold of the PCell PMCH decoding, then, there is no benefit to handing over to a new cell and, in block 814, the UE continues decoding the PMCH on the PCell. However, if the continued communication condition fails to meet the predetermined threshold, then, at block 816, the UE would start the reselection process to a new cell discovered in the neighbor cell search and begin decoding the PMCH for the data on the new cell.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, by a mobile device, at least one of that a primary cell (PCell) and a secondary cell (SCell) belong to a same multicast-broadcast single frequency network (MBSFN) area, or that the PCell and the SCell can broadcast a same service;
determining, by the mobile device, a communication state of the PCell and the SCell;
selecting, by the mobile device, to decode broadcast content on one of: the PCell, or the SCell, based on a comparison of signal quality on the PCell and the SCell, wherein the selecting is in response to the communication state indicating the SCell is active;
switching, by the mobile device, to decode the broadcast content on the PCell in response to the communication state indicating the SCell is one of: deactivated or released; and
in response to the communication state indicating that the SCell is released and that the PCell is released:
switching, by the mobile device, to decode the broadcast content on the PCell, and
initiating, by the mobile device, a neighbor cell search.

2. The method of claim 1, in response to one of: the switching to decode on the PCell or the selecting to decode broadcast content on the PCell, the method further comprising:
obtaining a communication condition associated with the PCell;
comparing the communication condition with a predetermined threshold;
continuing to decode the broadcast content on the PCell in response to the communication condition meeting the predetermined threshold; and
switching to decode the broadcast content on the SCell in response to the communication condition failing to meet the predetermined threshold, wherein the switching in response to the communication condition failing to meet the predetermined threshold is performed when the determined communication state fails to indicate that the PCell is released.

3. The method of claim 2, wherein the communication condition comprises one or more of:
a signal-to-noise metric of the MBSFN area of the PCell; and
a success rate of broadcast content decoding on the PCell.

4. The method of claim 2, wherein, when the determined communication state indicates that the PCell is released, the method further comprising:
initiating reselection to a new cell discovered during the neighbor cell search in response to the communication condition failing to meet the predetermined threshold.

5. The method of claim 1, in response to the selecting to decode broadcast content on the SCell, the method further comprising:
obtaining a communication condition associated with the SCell;
comparing the communication condition with a predetermined threshold;
continuing to decode the broadcast content on the SCell in response to the communication condition meeting the predetermined threshold; and
switching to decode the broadcast content on the PCell in response to the communication condition failing to meet the predetermined threshold.

6. The method of claim 1, further comprising:
determining that the PCell and the SCell can broadcast the same service in response to a first multicast control channel (MCCH) of the PCell and a second MCCH of the SCell containing a same temporary mobile group identity (TMGI).

7. A wireless communications apparatus, comprising:
means for determining, by a mobile device, at least one of that a primary cell (PCell) and a secondary cell (SCell) belong to a same multicast-broadcast single frequency network (MBSFN) area or that the PCell and the SCell can broadcast a same service;
means for determining, by the mobile device, a communication state of the PCell and the SCell;
means for selecting, by the mobile device, to decode broadcast content on one of: the PCell, or the SCell, based on a comparison of signal quality on the PCell and the SCell, wherein the selecting is in response to the communication state indicating the SCell is active;
means for switching, by the mobile device, to decode the broadcast content on the PCell in response to the communication state indicating the SCell is one of: deactivated or released; and
means, executable in response to the communication state indicating that the SCell is released and that the PCell is released:
for switching, by the mobile device, to decode the broadcast content on the PCell, and
for initiating, by the mobile device, a neighbor cell search.

8. The wireless communications apparatus of claim 7, in response to one of: the means for switching to decode on the PCell or the selecting to decode broadcast content on the PCell, the wireless communications apparatus further comprising:
means for obtaining a communication condition associated with the PCell;
means for comparing the communication condition with a predetermined threshold;
means for continuing to decode the broadcast content on the PCell in response to the communication condition meeting the predetermined threshold; and
means for switching to decode the broadcast content on the SCell in response to the communication condition failing to meet the predetermined threshold, wherein the means for switching in response to the communication condition failing to meet the predetermined threshold is performed when the determined communication state fails to indicate that the PCell is released.

9. The wireless communications apparatus of claim 8, wherein the communication condition comprises one or more of:
a signal-to-noise metric of the MBSFN area of the PCell; and
a success rate of broadcast content decoding on the PCell.

10. The wireless communications apparatus of claim 8, when the determined communication state indicates that the PCell is released, the wireless communications apparatus further comprising:
means for initiating reselection to a new cell discovered during the neighbor cell search in response to the communication condition failing to meet the predetermined threshold.

11. The wireless communications apparatus of claim 7, in response to the means for selecting to decode broadcast content on the SCell, the wireless communications apparatus further comprising:
means for obtaining a communication condition associated with the SCell;
means for comparing the communication condition with a predetermined threshold;
means for continuing to decode the broadcast content on the SCell in response to the communication condition meeting the predetermined threshold; and
means for switching to decode the broadcast content on the PCell in response to the communication condition failing to meet the predetermined threshold.

12. The wireless communications apparatus of claim 7, further comprising:
means for determining that the PCell and the SCell can broadcast the same service in response to a first multicast control channel (MCCH) of the PCell and a second MCCH of the SCell containing a same temporary mobile group identity (TMGI).

13. A non-transitory computer-readable medium comprising program code recorded thereon that, when executed by one or more computer processors, causes the one or more computer processors to:
determine, by a mobile device, at least one of that a primary cell (PCell) and a secondary cell (SCell) belong to a same multicast-broadcast single frequency network (MBSFN) area or that the PCell and the SCell can broadcast a same service;
determine, by the mobile device, a communication state of the PCell and the SCell;
select, by the mobile device, to decode broadcast content on one of: the PCell, or the SCell, based on a comparison of signal quality on the PCell and the SCell, wherein the selection is in response to the communication state indicating the SCell is active;
switch, by the mobile device, to decode the broadcast content on the PCell in response to the communication state indicating the SCell is one of: deactivated or released; and
in response to the communication state indicating that the SCell is released and that the PCell is released:
switch, by the mobile device, to decode the broadcast content on the PCell, and
initiate, by the mobile device, a neighbor cell search.

14. The non-transitory computer-readable medium of claim 13, in response to one of the switch to decode on the PCell or the selection to decode broadcast content on the PCell, the program code further causes the one or more computer processors to:
obtain a communication condition associated with the PCell;
compare the communication condition with a predetermined threshold;
continue to decode the broadcast content on the PCell in response to the communication condition meeting the predetermined threshold; and
switch to decode the broadcast content on the SCell in response to the communication condition failing to meet the predetermined threshold, wherein the switch in response to the communication condition failing to meet the predetermined threshold is performed when the determined communication state fails to indicate that the PCell is released.

15. The non-transitory computer-readable medium of claim 14, wherein the communication condition comprises one or more of:
a signal-to-noise metric of the MBSFN area of the PCell; and
a success rate of broadcast content decoding on the PCell.

16. The non-transitory computer-readable medium of claim 14, when the determined communication state indicates that the PCell is released, the program code further causes the one or more computer processors to:
initiate reselection to a new cell discovered during the neighbor cell search in response to the communication condition failing to meet the predetermined threshold.

17. The non-transitory computer-readable medium of claim 13, in response to the selection to decode broadcast content on the SCell, the program code further causes the one or more computer processors to:
obtain a communication condition associated with the SCell;
compare the communication condition with a predetermined threshold;
continue to decode the broadcast content on the SCell in response to the communication condition meeting the predetermined threshold; and
switch to decode the broadcast content on the PCell in response to the communication condition failing to meet the predetermined threshold.

18. The non-transitory computer-readable medium of claim 13, wherein the program code causes the one or more computer processors to:
determine that the PCell and the SCell can broadcast the same service in response to a first multicast control channel (MCCH) of the PCell and a second MCCH of the SCell containing a same temporary mobile group identity (TMGI).

19. An apparatus configured for wireless communication, comprising
at least one processor; and
a memory coupled to the at least one processor, wherein the at least one processor is configured to:
determine, by a mobile device, at least one of that a primary cell (PCell) and a secondary cell (SCell) belong to a same multicast-broadcast single frequency network (MBSFN) area or that the PCell and the SCell can broadcast a same service;
determine, by the mobile device, a communication state of the PCell and the SCell;
select, by the mobile device, to decode broadcast content on one of: the PCell, or the SCell, based on a comparison of signal quality on the PCell and the SCell, wherein the selection is in response to the communication state indicating the SCell is active;
switch, by the mobile device, to decode the broadcast content on the PCell in response to the communication state indicating the SCell is one of: deactivated or released; and
in response to the communication state indicating that the SCell is released and that the PCell is released:
switch, by the mobile device, to decode the broadcast content on the PCell, and
initiate, by the mobile device, a neighbor cell search.

20. The apparatus of claim 19, in response to one of: the switch to decode on the PCell or the selection to decode broadcast content on the PCell, the at least one processor is further configured to:
obtain a communication condition associated with the PCell;
compare the communication condition with a predetermined threshold;
continue to decode the broadcast content on the PCell in response to the communication condition meeting the predetermined threshold; and
switch to decode the broadcast content on the SCell in response to the communication condition failing to meet the predetermined threshold, wherein the switch in response to the communication condition failing to meet the predetermined threshold is performed when the determined communication state fails to indicate that the PCell is released.

21. The apparatus of claim 20, wherein the communication condition comprises one or more of:
a signal-to-noise metric of the MBSFN area of the PCell; and
a success rate of broadcast content decoding on the PCell.

22. The apparatus of claim 20, when the determined communication state indicates that the PCell is released, the processor is further configured to:
initiate reselection to a new cell discovered during the neighbor cell search in response to the communication condition failing to meet the predetermined threshold.

23. The apparatus of claim 19, in response to the selection to decode broadcast content on the SCell, the processor is further configured to:
obtain a communication condition associated with the SCell;
compare the communication condition with a predetermined threshold;
continue to decode the broadcast content on the SCell in response to the communication condition meeting the predetermined threshold; and
switch to decode the broadcast content on the PCell in response to the communication condition failing to meet the predetermined threshold.

24. The apparatus of claim 19, wherein the processor is configured to:
determine that the PCell and the SCell can broadcast the same service in response to a first multicast control channel (MCCH) of the PCell and a second MCCH of the SCell containing a same temporary mobile group identity (TMGI).
